(19) United States
(12) Patent Application Publication
(10) Pub. No.: US 2024/0317020 A1
(43) Pub. Date: Sep. 26, 2024

(54) DRIVE UNIT FOR A KINEMATIC SYSTEM IN A MOTOR VEHICLE

(71) Applicant: fischer automotive systems GmbH & Co. KG, Horb a.N. (DE)

(72) Inventor: Julian BRAUN, Horb (DE)

(73) Assignee: fischer automotive systems GmbH & Co. KG, Horb a.N. (DE)

(21) Appl. No.: 18/606,855

(22) Filed: Mar. 15, 2024

(30) Foreign Application Priority Data
Mar. 20, 2023 (DE) 10 2023 106 951.9

(51) Int. Cl. B60H 1/00; B60H 1/34

(52) U.S. Cl. CPC B60H 1/00871; B60H 2001/3478

(57) ABSTRACT

A drive unit for a kinematic system in a motor vehicle. In particular, the drive unit is provided for independently moving two movable elements, in particular blades for guiding an air current of an air vent. The movable elements are driven by way of an actuator plate, which includes a radial cam rotating and radially displacing a slide, which consecutively rotates two output elements. In a blocking position, the slide blocks the output elements to prevent a rotation.

### CROSS-REFERENCE TO RELATED APPLICATION

This application claims priority under 35 USC § 119 to German Patent Application No. 10 2023 106 951.9, filed Mar. 20, 2023, the entire disclosure of which is incorporated herein by reference.

### TECHNICAL FIELD

The invention relates to a drive unit for a kinematic system in a motor vehicle. The drive unit is, in particular, provided for pivoting blades or, generally speaking, air guide elements and/or a closing flap of an air vent in a motor vehicle. The blades, air guide elements, and closing flap form the kinematic system or are part of the kinematic system.

### DISCUSSION OF RELATED ART

The unexamined patent application DE 10 2021 119 416 A1 describes such a drive unit including a radial cam, which has circular arc-shaped cam branches, a zigzag-shaped shifting gate, from the corners of which the cam branches branch off in opposite directions, and a helical return cam, and including a sliding block engaging in the radial cam, which is moved back and forth along and in the radial cam and in the shifting gate and the cam branches, and in the process drives a distribution mechanism, which, in turn, moves two movable output elements of the drive unit chronologically consecutively and independently of one another.

### SUMMARY OF THE INVENTION

It is the object of the invention to design such a drive unit with a non-movement block for at least one output element.

The drive unit according to the invention is provided for a kinematic system in a motor vehicle. For example, blades or, generally speaking, air guide elements and/or a closing flap of an air vent, serving as a kinematic system, can be pivoted independently of one another by way of the drive unit according to the invention.

The drive unit according to the invention includes a cam control unit including a radial cam and a sliding block for independently moving two movable output elements, wherein the radial cam can be moved relative to the sliding block. In particular, the radial cam can be rotated about an axis of rotation, or the sliding block can be moved about the axis of rotation on a circular path, or a non-circular rotation path, and displaced radially with respect to the axis of rotation. The radial cam and the sliding block, however, may also be displaceable with respect to one another. The circular path or rotation path of the sliding block in relation to the radial cam does not have to be closed and can extend over less than a full rotation.

A sliding block here denotes a kind of scanning element, which moves along the radial cam during the relative movement of the radial cam or, conversely, along which the radial cam moves during the movement thereof, which is to say, the sliding block slides or rolls along at or on the radial cam and essentially scans the radial cam, with the radial cam moving the sliding block. The movement of the sliding block can be a forced movement, or the sliding block is, for example, urged by a spring element against the radial cam. The movement of the sliding block is used to move the two movable output elements. The output elements can be pivotable and/or displaceable.

The sliding block can move the output elements directly or indirectly, for example via a distribution mechanism.

The radial cam has at least one ramification into at least two cam branches and a shifting gate, which, during a back and forth movement of the radial cam relative to the sliding block, moves the sliding block consecutively from a first cam branch to a respective next cam branch, up to a last cam branch. The cam branches are sections of the radial cam, and the shifting gate is likewise a part of the radial cam from which the cam branches branch off and which consecutively moves the sliding block, when the sliding block is in the shifting gate, into the cam branches during the back and forth movement of the radial cam, and thus also of the shifting gate thereof, relative to the sliding block. For example, the shifting gate is a zigzag-shaped or meander-shaped part of the radial cam, from the corners of which, or from the curves of which, the cam branches branch off.

A first cam branch is assigned to a first of the two movable output elements, and a second cam branch is assigned to a second of the two movable output elements. When the sliding block is located in the first cam branch, the sliding block moves the first movable output element when the radial cam, or the first cam branch, is moved relative to the sliding block and thereby moves the sliding block. When the sliding block is located in the second cam branch, the sliding block moves the second movable output element when the radial cam, or the first cam branch, is moved relative to the sliding block and thereby moves the sliding block. As a result, the two movable output elements can be consecutively moved, independently of one another, in that the radial cam is moved back and forth relative to the sliding block so that the sliding block, from the shifting gate, which is part of the radial cam, consecutively reaches the first cam branch in which the sliding block moves the first movable output element, and the second cam branch in which the sliding block moves the second movable output element.

Furthermore, the radial cam of the cam control unit of the drive unit according to the invention includes a return cam, which is likewise part of the radial cam. The return cam moves the sliding block from the last cam branch back to the first cam branch during the movement of the radial cam relative to the sliding block. The last cam branch is the cam branch that the sliding block reaches last, during the back and forth movement of the radial cam, before reaching the return cam.

The invention additionally provides a non-movement block which, in a release position, allows the output elements to move and, in a blocking position, blocks at least one output element, and preferably both output elements, to prevent a movement. The non-movement block is actuated, which is to say is moved into the release position and/or into the blocking position, by the sliding block. It is also possible that the sliding block only moves the non-movement block either into the release position or into the blocking position and is moved in the opposite direction by a spring element, for example. The non-movement block avoids an unintentional movement of the movable output elements. A non-movement block can be provided for each movable output element, or a shared non-movement block can be provided for both output elements.

So as to actuate the non-movement block, which is to say move the non-movement block into the blocking position, the radial cam has a blocking section, which is likewise part of the radial cam. When the sliding block, during the movement of the radial cam relative to the sliding block, reaches the blocking section, the sliding block actuates the non-movement block, which thereupon blocks at least one output element, and preferably both output elements, to prevent a movement. The non-movement block has the advantage of blocking one output element, and preferably both output elements, to prevent undesirable movement. In particular, the output elements can be blocked to prevent movement in any position. When the sliding block is located in or at a part of the radial cam other than at or in the blocking section, the non-movement block is released, and the output elements can be moved.

In any case, the non-movement block is released when the sliding block, for moving an output element, is located in one of the cam branches of the radial cam.

When the sliding block is located in the blocking section of the radial cam, the radial cam has a defined position in relation to the sliding block, which is defined by the sliding block being located in the blocking section of the radial cam. This position can be established without the use of a sensor, for example by a sudden increase in the current of an electric motor moving the radial cam when a closed end of the blocking section of the radial cam strikes against the sliding block, or vice versa, the sliding block strikes against the closed end of the blocking section of the radial cam, and the radial cam or the sliding block is thus stopped. If the sliding block has previously completely passed through all cam branches, and possibly counter cam branches, of the radial cam, the sliding block has previously moved the two movable output elements into defined positions, whereby the positions of both the radial cam and the two movable output elements are known.

Proceeding from these positions, the two movable output elements can be moved independently of one another into any desired position by way of the drive unit according to the invention.

If the radial cam can be rotated, the cam branches preferably extend in a curved manner on a limited circumferential section around the axis of rotation of the radial cam. In particular, the cam branches are circular arc-shaped and concentric with respect to the axis of rotation of the radial cam.

In principle, the blocking section of the radial cam can branch off the radial cam at any arbitrary point. It is also possible, for example, that the blocking section leads as a kind of ramp or slope out of a plane or surface in which the radial cam is otherwise located. It is also possible, for example, that the blocking section branches off the radial cam at one point and leads back into the radial cam at another point. The blocking section may also simply be a section of the radial cam. Preferably, however, the blocking section is a stub cam, which is to say the blocking section has a closed end and leads into the radial cam, or branches off the radial cam, at another end.

According to one embodiment of the invention, the blocking section branches off the shifting gate, or off the return cam, after the last cam branch, which means that the sliding block reaches the blocking section after having exited the last cam branch as a result of the back and forth movement of the radial cam relative to the sliding block. The sliding block can reach the blocking section directly from the last cam branch, from the shifting gate, or from the return cam, before the sliding block reaches the first cam branch. From the blocking section, the sliding block again reaches the return cam, the shifting gate, or the first cam branch as a result of a limited return movement of the radial cam relative to the sliding block. The limited return movement is a movement of the radial cam relative to the sliding block, opposite the movement of the radial cam that moves the sliding block into the blocking section. The length of the return movement is such that the sliding block exits the blocking section and reaches the return cam, the shifting gate, or the first cam branch again.

So as to block the output elements to prevent a movement, according to one embodiment of the invention the output elements can be rotated about an axis of rotation or about axes of rotation. The two output elements and/or the radial cam can have a shared axis of rotation or different axes of rotation. For blocking to prevent a movement, which in this case is a rotation about the axis of rotation, the first output element includes inner teeth concentric with respect to the axis of rotation of the first output element and/or the second output element includes outer teeth concentric with respect to the axis of rotation of the second output element. In the blocking position, the non-movement block, for example, engages in the inner teeth of the first output element and/or in the outer teeth of the second output element in the manner of a pawl and blocks the particular output element to prevent the movement, which is to say to prevent the rotation about the axis of rotation. In the release position, the non-movement block is disengaged from the teeth. If the non-movement block only blocks one output element, the other output element does not require any teeth. Embodiments of the invention including a respective dedicated non-movement block for each of the two output elements are also possible.

According to one embodiment of the invention, the non-movement block is designed as a slide, or includes a slide, which is displaced by the sliding block into the blocking position when the sliding block reaches the blocking section of the radial cam. The slide includes an outer tooth which, in the blocking position, engages in the inner teeth of the first output element, blocking the same to prevent the rotation about the axis of rotation, and/or the slide includes an inner tooth which, in the blocking position, engages in the outer teeth of the second output element, blocking the same to prevent the rotation about the axis of rotation.

For a compact design of the drive unit according to the invention, the slide can have a hole that surrounds the axis of rotation of the second output element, in which the inner tooth is disposed which, in the blocking position of the slide or of the non-movement block, engages in the outer teeth of the second output element, which are concentric with respect to the axis of rotation of the second output element.

The blocking section of the radial cam is preferably located outside an area or outline that is enclosed by all other sections of the radial cam. If the cam branches extend around an axis of rotation in a curved manner, this means that the blocking section is located or ends radially outside a radially outermost cam branch, or radially within a radially innermost cam branch. If the movement of the radial cam is a displacement, the blocking section of the radial cam, in this embodiment of the invention, is located laterally next to the/all cam branches, and not between two cam branches. The blocking section of the radial cam can also be located radially within all other sections of the radial cam.

Preferably, the radial cam additionally includes a first counter cam branch and a second counter cam branch, which are likewise two cam branches, wherein the first counter cam branch is again assigned to the first movable output element, and the second counter cam branch is assigned to the second movable output element. When the sliding block is located in the first counter cam branch of the radial cam, the sliding block moves the first movable output element in a direction opposite that in the first cam branch, when the radial cam, or the first counter cam branch, is moved relative to the sliding block, and thereby moves the sliding block. When the sliding block is located in the second counter cam branch, the sliding block moves the second movable output element in a direction opposite that in the second cam branch, when the radial cam, or the second counter cam branch, is moved relative to the sliding block, and thereby moves the sliding block. This refinement of the invention allows the two movable output elements to be moved independently of one another into any position between two end positions using only a single drive.

In particular, the counter cam branches branch in opposite directions off the shifting gate of the radial cam, similarly to the cam branches, so that the sliding block, from the shifting gate, during the movement of the radial cam in one direction relative to the sliding block, reaches one of the cam branches, and during the movement in the other direction/return movement reaches one of the counter cam branches. The counter cam branches are cam branches of the radial cam, which are also referred to as counter cam branches here because the branches move the output elements in directions opposite those of the cam branches, when the sliding block is located in these branches, and the radial cam is moved relative to the sliding block.

In particular, the last cam branch is the second counter cam branch, or the second cam branch when there is no second counter cam branch.

According to an embodiment of the invention, a transfer element is provided, which transfers the movement of the sliding block to the movable output elements. A transfer element can be provided for each movable output element. When the sliding block is located in the first cam branch, or possibly in the first counter cam branch, the transfer element transfers the movement of the sliding block to the first movable output element. When the sliding block is located in the second cam branch, or possibly in the second counter cam branch, the transfer element transfers the movement of the sliding block to the second movable output element. In particular, the transfer element is designed in one piece with the sliding block.

The transfer element can also form or include the non-movement block. This means that the sliding block, upon reaching the blocking section, moves the transfer element and, by way of the transfer element, the non-movement block into a blocking position, in which the transfer element or the non-movement block blocks an output element, or preferably both movable output elements, to prevent a movement.

The features and feature combinations, designs, and embodiments of the invention mentioned above in the description, and the features and feature combinations mentioned hereafter in the description of the figures and/or shown in a figure, can be used not only in the respective indicated or illustrated combination, but also in other essentially arbitrary combinations, or alone. Embodiments of the invention that do not include all the features of a dependent claim are possible. It is also possible to replace individual features of a claim with other disclosed features or feature combinations. Embodiments of the invention that do not include all the features of the exemplary embodiment, but an essentially arbitrary portion of the characterizing features of the exemplary embodiment, are possible.

### BRIEF DESCRIPTION OF THE DRAWINGS

The invention will be described in more detail hereafter based on an exemplary embodiment shown in the drawings. In the drawings:

FIG. 1 shows a drive unit according to the invention in a perspective illustration;

FIG. 2 shows a front view of the drive unit from FIG. 1 without output elements;

FIG. 3 shows a front view of two output elements of the drive unit from FIG. 1 from beneath;

FIG. 4 shows an enlarged illustration of a detail of a first output element of the drive unit from FIG. 1; and

FIG. 5 shows an enlarged illustration of a detail of a second output element of the drive unit from FIG. 1.

### DETAILED DESCRIPTION OF THE INVENTION

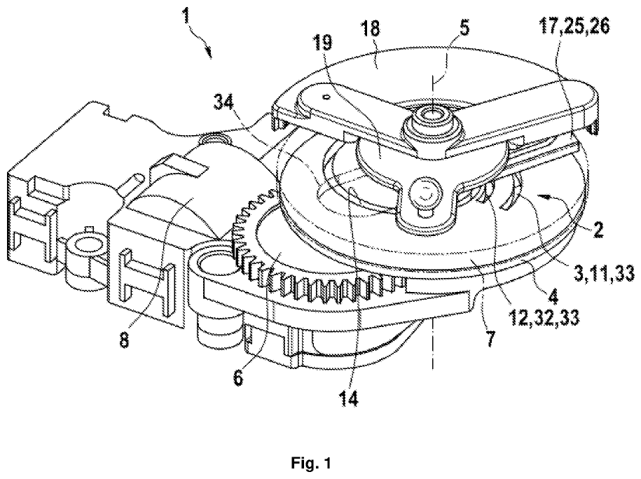

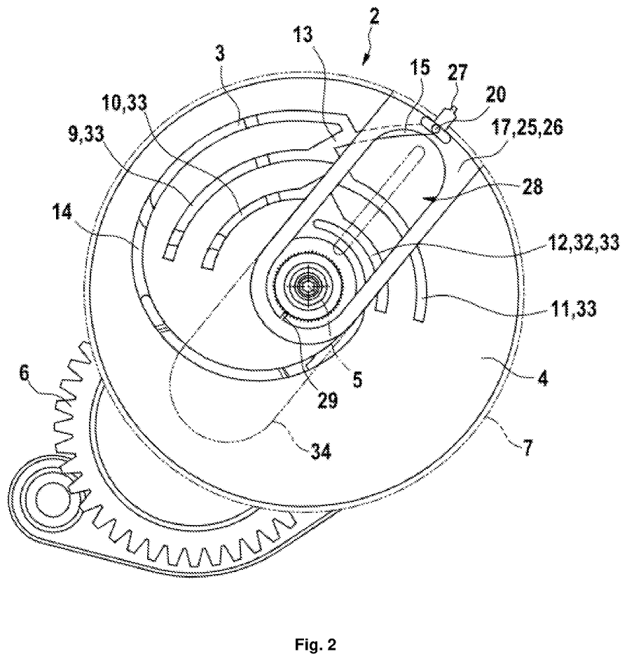

The drive unit 1 according to the invention shown in FIGS. 1 and 2 is provided for a kinematic system in a motor vehicle. In the exemplary embodiment, the drive is used to pivot two intersecting blades of an air vent, which guide an air current out of the air vent into a passenger compartment of the motor vehicle in two different directions. For example, a horizontal blade guides the air current vertically, and a vertical blade guides the air current laterally to the left and right. In principle, two arbitrary, movable, which is to say, displaceable and/or pivotable, elements can be moved, independently of one another, into arbitrary positions in each case between two end positions of the two movable elements by way of the drive unit 1 according to the invention.

The drive unit 1 according to the invention includes a cam control unit 2 including a radial cam 3, which in the exemplary embodiment is designed as a slot in an actuator plate 4, which in the exemplary embodiment is circular and non-rotatable.

The radial cam 3 includes four cam branches 33, a shifting gate 13, a return cam 14, and a blocking section 15, which are all sections or parts of the radial cam 3. Two of the four cam branches 33 will also be referred to hereafter as counter cam branches 11, 12.

The shifting gate 13 in the exemplary embodiment is zigzag-shaped and extends radially from the outside to the inside in the actuator plate 4. Consecutive corners of the shifting gate 13, which is zigzag-shaped in the exemplary embodiment, are in each case offset opposite one another in a circumferential direction of the actuator plate 4 and disposed at a decreasing radial distance with respect to an axis in the actuator plate 4. The axis of the actuator plate 4 is also an axis of rotation 5 of a rotating plate 7 and is referred to hereafter as such, even if the actuator plate 4 is non-rotatable.

In the exemplary embodiment, the four cam branches 33 extend in a circular arc-shaped manner concentrically around the axis of rotation 5, wherein radial distances between the cam branches 33 and the axis of rotation 5 and radii of the cam branches 33 decrease from one cam branch 33 to the next cam branch 33. At the corners of the zigzag-shaped shifting gate 13, the curve branches 33 branch off the radial cam 3, with the radial distance of the corners of the shifting gate 13 with respect to the axis of rotation 5 serving as the radius.

The return cam 14 of the radial cam 3 leads helically, which is to say, with a steadily increasing radius of curvature and at a steadily increasing radial distance with respect to the axis of rotation 5, from a radially inner end of the shifting gate 13 back to a radially outer end of the shifting gate 13. The radially inner end of the shifting gate 13 is disposed at a smaller radial distance with respect to the axis of rotation 5 than a radially innermost cam branch 12, and the radially outer end of the shifting gate 13 is disposed at a larger radial distance with respect to the axis of rotation 5 than a radially outermost cam branch 9. In the exemplary embodiment, the return section 14 extends over a circumferential section of almost 360°; however, this is not mandatory for the invention.

At a corner radially outside the radially outermost cam branch 9, the blocking section 15 branches off the zigzag-shaped shifting gate 13, extending from there obliquely to the outside. Similarly to the cam branches 33, the blocking section 15 is designed as a stub cam, which is to say has a closed end. The blocking section 15 is disposed at a larger radial distance with respect to the axis of rotation 5 than the cam branches 33, which is to say the blocking section 15 is located radially outside the cam branches 33. In the circumferential direction, the blocking section 15 extends over a smaller circumferential angle than the cam branches 33, which in the exemplary embodiment extend over approximately 90° in the circumferential direction.

A peg, which is referred to as a sliding block 16 here and which can also be interpreted as a scanning element of the radial cam 3, engages in the radial cam 3. The sliding block 16 projects from a slide 17 toward the radial cam 4 so that the sliding block 16 engages in the radial cam 3. The slide 17 is displaceably guided in an elongated hole 34 in the rotating plate 7, which forms a sliding guide for the slide 17. The rotating plate 7 is disposed coaxially with respect to the actuator plate 4, on the same side of the actuator plate 4 as the slide 17, and the rotating plate 7 can be rotated about the axis of the actuator plate 4, serving as the axis of rotation 5. The rotating plate 7 including the elongated hole 34 is illustrated in a see-through manner and with dash-double-dotted lines in FIGS. 1 and 2 because otherwise the actuator plate 4 including the radial cam 3 would be concealed.

The elongated hole 34 is provided radially with respect to the axis of rotation 5 in the rotating plate 7, which can be rotated about the axis of rotation 5. The slide 17 can be displaced radially with respect to the axis of rotation 5 by a displacement in the elongated hole 34, and the slide 17 is moved on a curve about the axis of rotation 5 by a rotation of the rotating plate 7 by a limited angle of rotation. Without a radial movement of the slide 17, the path thereof is a circular arc that is concentric with respect to the axis of rotation 5. When also moved radially, the slide 17 moves on a curved path about the axis of rotation 5, the radial distance of which with respect to the axis of rotation 5 changes.

The radial movement of the slide 17 is generated by the radial cam 3 of the non-rotatable actuator plate 4 when the rotating plate 7 is rotated about the axis of rotation 5 and, in the process, the slide 17, having the sliding block 16 thereof engaging in the radial cam 3, is moved on curved paths about the axis of rotation 5. In particular, the shifting gate 13 and the return cam 14 move the slide 17, during the movement thereof about the axis of rotation, radially with respect to the axis of rotation 5.

For rotationally driving the rotating plate 7, the drive unit 1 according to the invention includes an electric motor 8, which rotationally drives the rotating plate 7 via a gear wheel 6. When the rotating plate 7 rotates, the slide 17 moves in relation to the non-rotatable actuator plate 4 with the likewise non-rotatable and fixed radial cam 3.

The radially outermost cam branch 33 is also referred to as the first cam branch 9 here. A next radially to the inside cam branch 33 is also referred to as the first counter cam branch 11 here. A cam branch 33 that, in turn, is next radially to the inside is also referred to as the second cam branch 10 here, and the cam branch 33 that is next radially to the inside, which is the radially innermost cam branch 33, is also referred to as the second counter cam branch 12 here and forms a last cam branch 32. The first and second cam branches 9, 10 extend in a circumferential direction opposite that of the blocking section 15 and the two counter cam branches 11, 12.

The shifting gate 13 is shaped and disposed so that, during the alternating back and forth rotation of the rotating plate 7 including the slide 17 in the radial elongated hole 34 of the rotating plate 7 about the axis of rotation 5, the sliding block 16, proceeding from the blocking section 15, reaches the outermost cam branch 9, and thereafter consecutively the first counter cam branch 11, the second cam branch 10, and finally the radially innermost, second counter cam branch 12. From one cam branch 33 to the next, the shifting gate 13 incrementally moves the sliding block 16 radially to the inside. By way of the sliding block 16, the slide 17, from which the sliding block 16 projects, incrementally moves radially with respect to the axis of rotation 5. The shifting gate 13 is shaped and disposed so as to move the sliding block 16 radially to the inside, to the radially inwardly next cam branch 33, when the sliding block 16 exits a cam branch 33, as a result of a rotation of the rotating plate 7 with the radial cam 3, and enters the next inner cam branch 33.

From the radially innermost cam branch 12, the sliding block 16, upon renewed reversal of the direction of rotation of the rotating plate 7 by way of the radial cam 3, reaches the return section 14, which moves the sliding block 16 radially to the outside, and back into the blocking section 15.

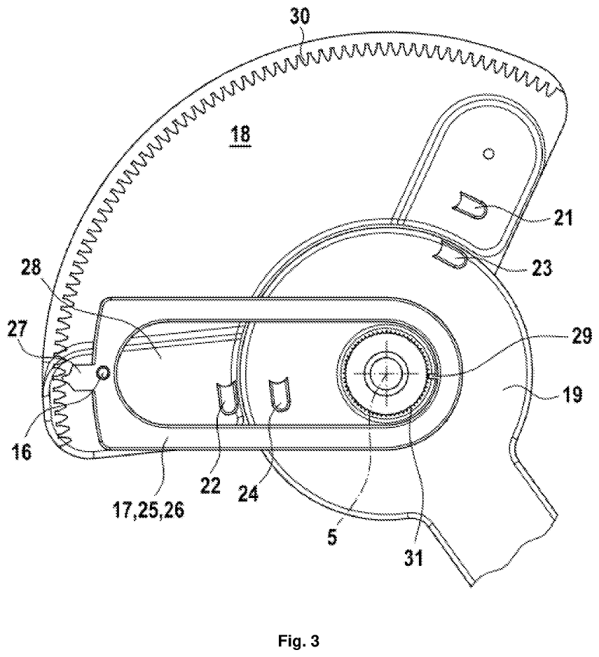

The drive unit 1 according to the invention includes two output elements 18, 19, which are disposed coaxially with the rotating plate 7 and the actuator plate 4 and can be rotated about the axis of rotation 5 of the rotating plate 7. The two output elements 18, 19 are rotated separately from one another, and chronologically consecutively, back and forth about the axis of rotation 5 by the slide 17 during the back and forth rotation thereof. The output elements 18, 19 are not shown in FIG. 2 since these would conceal the actuator plate 4 including the radial cam 3. FIGS. 3 to 5 show the two output elements 18, 19 from opposite sides compared to FIGS. 1 and 2.

For rotating the two output elements 18, 19 back and forth, the slide 17 includes a peg, which projects toward the output elements 18, 19 and serves as a driver 20 that, together with the slide 17, moves radially with respect to the axis of rotation 5 and moves on a circular path about the axis of rotation 5 during rotation of the slide 17.

Each of the two output elements 18, 19 includes two followers 21, 22, 23, 24, which project from the output elements 18, 19 toward the slide 17 and which are spaced apart from one another in the circumferential direction (FIG. 3). A circumferential angle by which the followers 21, 22, 23, 24 of the two output elements 18, 19 are spaced apart from one another approximately corresponds to the circumferential angle by which the cam branches 33 extend. Each follower 21, 22, 23, 24 is assigned to one of the cam branches 33, which is to say the followers 21, 22, 23, 24 of the two output elements 18, 19 are disposed at such a radial distance with respect to the axis of rotation 5 that the driver 20 of the slide 17 strikes against the assigned follower 21, 22, 23, 24 when the sliding block 16 of the slide 17 is located in the particular cam branch 33.

When the sliding block 16 of the slide 17, during a rotation of the rotating plate 7, reaches the first cam branch 9 from the shifting gate 13, the driver 20 of the slide 17 strikes against a first follower 21 of the first output element 18, and rotates the first output element 18 in the direction of rotation. The angle of rotation of the first output element 18 is dependent on the angle of rotation of the rotating plate 7. The first output element 18 can be rotated into any rotational position until the sliding block 16 of the slide 17 reaches the end of the first cam branch 9.

During a subsequent rotation of the rotating plate 7 in the opposite direction of rotation, the sliding block 16 of the slide 17 reaches the first counter cam branch 11 of the radial cam 3 from the first cam branch 9, via the shifting gate 13. In the process, the driver 20 of the slide 17 strikes against a second follower 22 of the first output element 18, rotating the first output element 18 back. The output element 18 can be rotated back into any arbitrary position until, at a maximum, the sliding block 16 strikes against the end of the second counter cam branch 12 of the radial cam 3. If the first output element 18 is not to be rotated back, the rotating plate 7 is only rotated back until the sliding block 16 reaches the shifting gate 13 from the first cam branch 9, and from there reaches the corner of the zigzag-shaped shifting gate 13, from which the first counter cam branch 11 branches off.

Thereafter, the direction of rotation of the rotating plate 7 is reversed again. The rotating plate 7 is again rotated so that the sliding block 16 of the slide 17 reaches the second cam branch 10, whereby the driver 20 strikes against a first follower 23 of the second output element 19, rotating the same. Finally, the rotating plate 7 is rotated back again, whereby the sliding block 16 reaches the second counter cam branch 12 from the second cam branch 10 of the radial cam 3, via the shifting gate 13. In the process, the driver 20 of the slide 17 strikes against a second follower 24 of the second output element 19, rotating the same back.

In the described manner, the two output elements 18, 19 can be consecutively rotated, independently of one another, into any rotational position between two end positions of the two output elements 18, 19 as a result of repeated back and forth rotations of the rotating plate 7. The end positions of the output elements 18, 19 are established by the extension of the cam branches 33 in the circumferential direction, and by the distance of the followers 21, 22, 23, 24 of the output elements 18, 19 in the circumferential direction.

The cam branches 11, 12 are also referred to as counter cam branches 11, 12 since the output elements 18, 19 are rotated in one direction when the sliding block 16 is located in the cam branches 9, 10, and the output elements 18, 19 are rotated in opposite directions when the sliding block 16 is located in the counter cam branches 11, 12.

As a result of a rotation of the rotating plate 7, the sliding block 16 reaches the shifting gate 13 again from the second counter cam branch 12 of the radial cam 3, which also forms the innermost and the last cam branch 12, and, after the direction of rotation has been reversed, reaches the return cam 14. The rotating plate 7 is rotated until the sliding block 16 reaches the blocking section 15 and strikes against the end thereof. The sliding block 16 striking against the end of the blocking section 15 can be detected without the use of any sensor whatsoever, by a stepped or sudden increase in a motor current of the electric motor 8, which rotationally drives the rotating plate 7. The electric motor 8 is thereupon shut off, and the rotational position of the rotating plate 7 is known.

So as to rotate the two output elements 18, 19 into defined positions, the rotating plate 7 is rotated back and forth until the sliding block 16 consecutively reaches all four cam branches 33, and thereafter returns via the return cam 14 to the end of the blocking section 15. The rotating plate 7 is in each case rotated back and forth until the sliding block 16 reaches the ends of the cam branches 33 or, in any case, the ends of the two counter cam branches 11, 12. In this way, the output elements 18, 19 are rotated into positions established by the sliding block 16 reaching the ends of the cam branches 33, or the ends of the counter cam branches 11, 12. From these established and known positions, the two output elements 18, 19 of the drive unit 1 according to the invention can be rotated into any position between the end positions as a result of back and forth rotations of the rotating plate 7 as described above.

The slide 17, which co-rotates as a result of the rotation of the rotating plate 7 and the sliding block 16 engaging in the radial cam 4, and which is moved radially with respect to the axis of rotation 5, also forms a transfer element 25 of the drive unit 1 according to the invention, which rotates the two output elements 18, 19 via the driver 20 of the transfer element and the respective two followers 21, 22, 23, 24 of the output elements 18, 19.

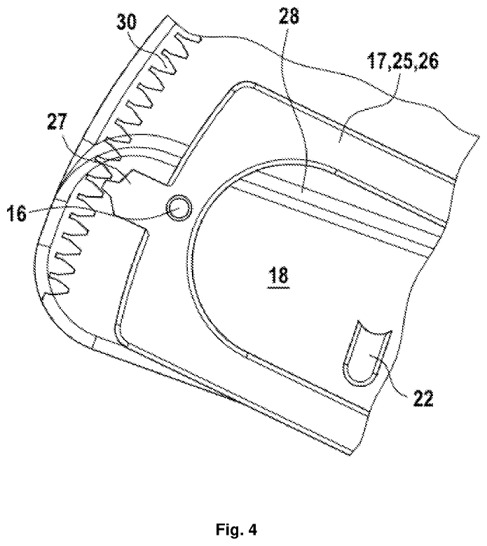

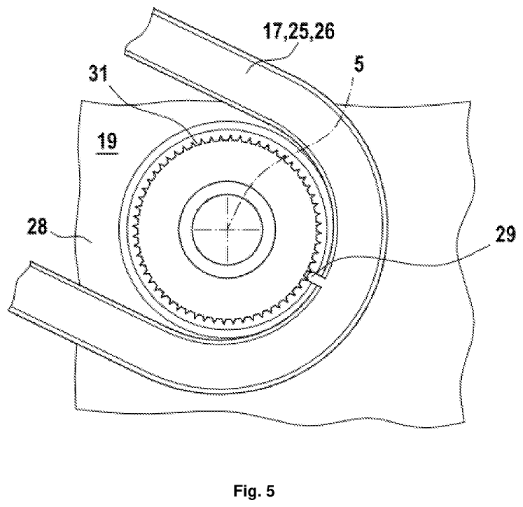

In addition, the slide 17 forms a non-rotation or non-movement block 26 for blocking the two output elements 18, 19 to prevent inadvertent rotation or movement. For the design as a non-movement block 26, the slide 17 includes an outer tooth 27 at a radially outer end, and an inner tooth 29 in a radial elongated hole 28 at a radially inner end. When the rotating plate 7 is rotated so that the sliding block 16 reaches the end of the blocking section 15 of the radial cam 3, the sliding block 16 moves the slide 17 into a blocking position in a radially outermost position in relation to the axis of rotation 5. In the blocking position of the slide 17, which also forms the non-movement block 26, the outer tooth 27 of the slide 17 engages in inner teeth 30 of the first output element 18, holding the same in a non-rotatable manner (FIGS. 3 and 4). Moreover, in the blocking position of the slide 17, the inner tooth 29 engages in outer teeth 31 of the second output element 19, holding the same in a non-rotatable manner (FIGS. 3 and 5). This means that the slide 17, which also forms the non-movement block 26, in the blocking position fixes the two output elements 18, 19 in the respective rotational positions thereof. The inner teeth 30 of the first output element 18 extend on a circular arc over a limited circumferential section concentrically around the axis of rotation 5. The outer teeth 31 of the second output element 19 are located in the elongated hole 28 of the slide 17 and concentrically enclose the axis of rotation 5.

When the rotating plate 7 is rotated back so that the sliding block 16 of the slide 17, which also forms the non-movement block 26, exits the blocking section 15, the sliding block 16 displaces the slide 17 radially so far to the inside, toward the axis of rotation 5, that the outer tooth 27 of the slide 17 is disengaged from the inner teeth 30 of the first output element 18, and the inner tooth 29 of the slide 17 is disengaged from the outer teeth 31 of the second output element 19. As a result, the two output elements 18, 19 can be moved or rotated freely again. The position of the slide 17, in which the outer tooth 27 and the inner tooth 29 are not engaged with the inner teeth 30 and the outer teeth 31 of the two output elements 18, 19, is referred to as the release position of the slide 17 or of the non-movement block 26. In the exemplary embodiment, the non-movement block 26 is in the release position when the sliding block 16 is not located in the blocking section 15, but in another section of the radial cam 3, which is to say in one of the four cam branches 33, the shifting gate 13 or the return cam 15.

Two rotatable and/or displaceable, which is to say movable, elements, which are not shown, are connected in an articulated manner, for example by way of coupling rods, to the two output elements 18, 19 of the drive unit 1 according to the invention, and can be consecutively moved, independently of one another, by way of the drive unit 1 and blocked in the respective positions thereof to prevent undesirable movement. The movable elements that are connected in an articulated manner to the two output elements 18, 19 are, for example, blades of an air vent, which is not shown, and guide an air current out of the air vent into a passenger compartment of a motor vehicle vertically and laterally.

### LIST OF REFERENCE SIGNS

1 drive unit
2 cam control unit
3 radial cam
4 actuator plate
axis of rotation
6 gear wheel
7 rotating plate
8 electric motor
9 first cam branch
second cam branch
11 first counter cam branch
12 second counter cam branch
13 shifting gate
14 return cam
blocking section
16 sliding block
17 slide
18 first output element
19 second output element
driver
21 first follower of the first output element 18
22 second follower of the first output element 18
23 first follower of the second output element 19
24 second follower of the second output element 19
25 transfer element
26 non-movement block
27 outer tooth
28 elongated hole
29 inner tooth
30 inner teeth
31 outer teeth
32 last cam branch
33 cam branch
34 elongated hole

1. A drive unit for a kinematic system in a motor vehicle, comprising a cam control unit for moving a first movable output element and for, independently thereof, moving a second movable output element, the cam control unit comprising a radial cam and a sliding block, which, during a movement of the radial cam relative to the sliding block, moves along the radial cam and, in the process, is moved by the radial cam, and which, during the movement thereof, moves the first and second movable output elements, the radial cam having at least one ramification into at least two cam branches and a shifting gate, which, during a back and forth movement of the radial cam relative to the sliding block, moves the sliding block consecutively from a first cam branch to a last cam branch, the sliding block in the first cam branch, during the relative movement of the radial cam with respect to the sliding block, moving the first movable output element, and in a second cam branch of the radial cam, during the relative movement of the radial cam with respect to the sliding block, moving the second movable output element, and the radial cam comprising a return cam, which returns the sliding block to the first cam branch after exiting a last cam branch, wherein the drive unit comprises a non-movement block, which is actuated by the sliding block; the radial cam comprises a blocking section; and i the sliding block moves the non-movement block into a blocking position when the sliding block reaches the blocking section of the radial cam, the non-movement block in the blocking position blocking at least one output element to prevent a movement.

2. The drive unit according to claim 1, wherein the blocking section of the radial cam, after the last cam branch, branches off the shifting gate or off the return cam, and is reached by the sliding block from the shifting gate or from the return cam, after the last cam branch, when returning from the last cam branch to the first cam branch.

3. The drive unit according to claim 1, wherein the radial cam and the first output element and/or the second output elements can be rotated about an axis of rotation; and the first output element has inner teeth, which extend in a circular arc-shaped manner concentrically around the axis of rotation and in which the non-movement block, in the blocking position, engages so as to block the first output element to prevent a rotation about the axis of rotation, and/or in that the second output element has outer teeth concentric with respect to the axis of rotation, in which the non-movement block, in the blocking position, engages so as to block the second output element to prevent a rotation about the axis of rotation.

4. The drive unit according to claim 3, wherein the non-movement block comprises a slide, which is displaced by the sliding block into the blocking position when the sliding block reaches the blocking section of the radial cam; and the slide comprises an outer tooth which, in the blocking position, engages in the inner teeth of the first output element, blocking the same to prevent the rotation about the axis of rotation, and/or that the slide comprises an inner tooth which, in the blocking position, engages in the outer teeth of the second output element, blocking the same to prevent the rotation about the axis of rotation.

5. The drive unit according to claim 4, wherein the slide has a hole which surrounds the axis of rotation and in which the inner tooth is disposed.

6. The drive unit according to claim 1, wherein the blocking section of the radial cam is located outside an outline defined by the cam branches.

7. The drive unit according to claim 6, wherein the blocking section is located outside an outline of all other sections of the radial cam.

8. The drive unit according to claim 1, wherein the radial cam comprises a first counter cam branch which, during the relative movement of the radial cam with respect to the sliding block, moves the first movable output element in a direction opposite that of the first cam branch; and the radial cam comprises a second counter cam branch which, during the relative movement of the radial cam with respect to the sliding block, moves the second movable output element in a direction opposite that of the second cam branch.

9. The drive unit according to claim 3, wherein the cam branches extend in a curved manner on a limited circumferential section around the axis of rotation.

10. The drive unit according to claim 1, wherein the shifting gate connects the cam branches in a zigzag-shaped manner.

11. The drive unit according to claim 1, wherein the sliding block moves the output elements via a transfer element, which distributes the movement of the sliding block among the output elements.

12. The drive unit according to claim 11, wherein the transfer element comprises the non-movement block.

13. The drive unit according to claim 1, configured to pivot two air guide elements of an air vent.

14. The drive unit according to claim 5, wherein the hole is an elongated hole.
